(19) United States
(12) Patent Application Publication
(10) Pub. No.: US 2008/0272895 A1
(43) Pub. Date: Nov. 6, 2008

(54) Slim-Type Magnetic Buzzer

(76) Inventors: Kim Jae Young, Busan (KR); Lee Woo Bum, Busan (KR); Eom Seong Ki, Busan (KR)

Correspondence Address: FISH & ASSOCIATES, PC;ROBERT D. FISH, 2603 Main Street, Suite 1050, Irvine, CA, 92614-6232, US

(21) Appl. No.: 11/969,369

(22) Filed: Jan. 4, 2008

(30) Foreign Application Priority Data
May 2, 2007 (KR) 20-2007-0007230

(51) Int. Cl. G08B 3/00

(52) U.S. Cl. 340/388.4

(57) ABSTRACT

Contemplated magnetic buzzers include an elliptical or oblong resonator and magnet that significantly improve sound pressure level and audio quality. Most preferably, the resonator and magnet are disposed in a housing that comprises tab insertion channels that are fluidly coupled to solder channels, and tabs are coupled to and disposed within correspondingly shaped recesses in the housing to facilitate SMT mounting and to improve electrical contact stability.

This application claims priority to our Korean utility model application with the serial number 20-2007-0007230, which was filed May 2, 2007.

### FIELD OF THE INVENTION

The field of the invention is magnetic buzzers.

### BACKGROUND OF THE INVENTION

As the overall size and weight of various electronic devices (e.g., cellular phones, WAP phones, PDAs, webpads, etc.) decreases, there is an increasing need to reduce the size and weight of associated components of these devices. For example, sound producing components such as buzzers have not substantially changed size as under most circumstances reduction in size also led to a reduction in sound pressure level (SPL) and/or audio quality.

Prior Art FIG. 1 shows an exemplary diagram of a magnetic buzzer that is typically used to provide an audible alert signal. Here, the housing (1) has typically an square form with a circular receiving portion (2) at the center of the upper side of the housing. In most devices, two pairs of tabs (3) are joined on the outside of the housing to the printed circuit board (PCB) using heat or chip solder. A yoke (4) is inserted into the center of the receiving portion, and a coil (5) is wound around the yoke, wherein the coil is electrically coupled to the tabs. A circular ring-shaped magnet (6) is inserted into the receiving portion at a fixed distance from the outside of the coil, and a resonator (7), which generates sound in response to an external signal, is affixed to the top of the magnet (6). Lid (8) is placed on top of the housing (1) to complete the buzzer and has a central opening (9) to allow sound to emanate from the housing. However, as the circular magnet and vibrating plate are joined to the yoke and coil in the circular receiving part, ordinary magnetic buzzers often fail to emit a high-pitched sound at high SPL due to the relatively small excursion of the vibrating plate. Moreover, as the two pairs of tabs are formed on either side of the housing, mounting efficiency in surface mount technology (SMT) is often reduced.

Thus, while various configurations and methods of magnetic buzzers are known in the art, all or almost all of them suffer from one or more disadvantages. Therefore, there is still a need for improved configurations and methods of magnetic buzzers.

### SUMMARY OF THE INVENTION

The present invention is directed to improved configurations and methods for magnetic buzzers in which the resonator (and most typically also the magnet) have an ellipsoid or oblong shape to provide for significantly enhanced SPL and audio quality. Most preferably, the housing of contemplated magnetic buzzers includes a solder channel that simplifies forming electrical contact between the coil and the conductive tabs, which are most preferably accommodated by indentations in the housing to render the buzzer especially suitable for surface mount technology.

In one aspect of the inventive subject matter, a magnetic buzzer has a housing having a cavity, a solder conduit, and a tab insertion conduit that is formed between the cavity and an outside surface of the housing, wherein the solder conduit is fluidly coupled to the tab insertion conduit. A yoke is disposed in the cavity, a coil surrounds the yoke, and a magnet has elliptical or oblong shape. The magnet preferably has an upper support element and a lower retraction channel, wherein the magnet is disposed in the cavity and surrounds the yoke and coil. Most preferably, a resonator has elliptical or oblong shape, wherein the resonator is coupled to the upper support element, and a tab is partially located in the tab insertion conduit, and solder in the solder conduit in an amount effective to conductively fasten a winding of the coil to the tab, wherein the winding extends at least partially through the lower retraction channel.

In especially preferred buzzers, the outside surface of the housing is recessed to form a tab holding groove that is configured to receive substantially all of the tab that is outside of the housing, and/or the cavity comprises a protrusion that is configured to allow positioning of the magnet at a position above a yoke plate. Where desired, the housing may further comprise a support structure that is configured to allow coupling of a cover to the housing in a position above the resonator. Typically, the elliptical shape is characterized by a ratio of major axis to minor axis of at least 1.05, more typically of at least 1.1, and most typically of at least 1.25. Alternatively, the resonator may also have a rectangular shape. It is further generally preferred that the resonator comprises a vibrating plate and a magnetic element that is centrally located on the vibrating plate.

Viewed from a different perspective, a magnetic buzzer with a lower housing portion with tab insertion grooves, a yoke located in an interior of the lower housing portion, a coil wound around the yoke, and an upper housing portion coupled to the lower housing portion comprises a pair of tabs inserted into the respective tab insertion grooves, wherein the tabs are electrically connected to the coil and an optional power source. Contemplated buzzers include an elliptical or oblong magnet located in the interior of the lower housing portion, further have a supporting projection at a predetermined height along the top of the magnet, and still further have retraction grooves formed at either side of the bottom of the magnet. Most preferably, an elliptical or oblong resonator is coupled to the supporting projection, wherein the resonator further comprises a magnetic plate coupled to the top center of the resonator.

In especially preferred aspects, the interior has a corresponding elliptical or oblong shape so as to permit insertion of the magnet, a supporting projection in the interior that is configured to support the upper housing portion, and a yoke insertion groove in the interior that is configured to allow insertion of the yoke. Where desired, solder grooves are formed on either side of the supporting projection, and tab insertion grooves formed on either side of the lower housing portion that are in fluid communication with the solder grooves. Elliptical resonators are generally preferred, however, rectangular and other oblong shapes are also deemed suitable. It is further preferred that the resonator comprises a vibrating plate and a magnetic element that is centrally located on the vibrating plate.

Various objects, features, aspects and advantages of the present invention will become more apparent from the following detailed description of preferred embodiments of the invention.

### BRIEF DESCRIPTION OF THE DRAWING

Prior Art FIG. 1 is a plane diagram schematically showing a conventional known magnetic buzzer.

FIG. 2 is an exploded oblique view of one exemplary slim-type magnetic buzzer according to the inventive subject matter.

FIG. 3 is an exploded oblique view of another exemplary slim-type magnetic buzzer according to the inventive subject matter.

FIG. 4 is a cross-section showing the assembled slim-type magnetic buzzer of FIG. 2.

FIG. 5 is a graph comparatively depicting SPL of a conventional buzzer and a buzzer according to the inventive subject matter over a frequency range.

### DETAILED DESCRIPTION

The inventors have discovered that heretofore known problems associated with magnetic buzzers can be reduced, or even entirely avoided in configurations and methods in which the vibration amplitude of the vibrating plate is increased by forming the resonator and preferably also the magnet in an elliptical or oblong form. Such configurations significantly increase the volume of vibrating air in the interior of the case. Moreover, by providing increased width of the tabs and joining the tabs to the sides of the housing (most preferably via a solder channel and indentation in the housing), a slim-type magnetic buzzer with enhanced the surface mount technology (SMT) mounting capability is produced.

As used herein, the terms “magnetic buzzer” or “buzzer” are used interchangeably and refer to an electro-acoustic transducer in which a static voice coil is located in an arrangement of magnets or magnet such that changing current through the voice coil will result in movement of a resonator that is disposed in the magnetic field of the arrangement of magnets or magnet and the magnetic field generated by the voice coil. Therefore, electromagnetic transducers in which the voice coil is movable relative to the arrangement of magnets or a magnet (as commonly found in cone- or dome-type speakers) are expressly excluded from the term “magnetic buzzer”.

It is generally contemplated that a buzzer will include a housing having a cavity, a solder conduit, and a tab insertion conduit that is formed between the cavity and an outside surface of the housing, wherein the solder conduit is fluidly coupled to the tab insertion conduit. A yoke disposed in the cavity, a coil surrounds the yoke, and a magnet has elliptical or oblong shape and further has an upper support element and a lower retraction channel, wherein the magnet is disposed in the cavity and surrounds the yoke and coil. Most typically, a resonator has elliptical or oblong shape and the resonator is coupled to the upper support element. It is further contemplated that the buzzer has a tab partially located in the tab insertion conduit, and solder in the solder conduit in an amount effective to conductively fasten a winding of the coil to the tab, wherein the winding extends at least partially through the lower retraction channel.

Therefore, contemplated magnetic buzzers have a lower housing portion with tab insertion grooves, a yoke located in an interior of the lower housing portion, a coil wound around the yoke, and an upper housing portion coupled to the lower housing portion, wherein the buzzer further has a pair of tabs inserted into the respective tab insertion grooves, wherein the tabs are electrically connected to the coil and an optional power source. An elliptical or oblong magnet is further located in the interior of the lower housing portion, has a supporting projection at a predetermined height along the top of the magnet, and still further has retraction grooves formed at either side of the bottom of the magnet. An elliptical or oblong resonator is further coupled to the supporting projection, wherein the resonator further comprises a magnetic plate coupled to the top center of the resonator.

In a preferred aspect of the inventive subject matter, contemplated magnetic buzzers can generate high-pitched sound at significantly improved SPL (relative to buzzers having a circular resonator) due to an increase in the vibration amplitude of the resonator which is achieved by raising the resonance volume. Increased resonance volume is preferably generated by forming both the magnet and the resonator into an elliptical or oblong shape. Consequently, it is generally preferred that a magnetic buzzer comprises a lower housing portion in which a receiving part is preferably formed as a cavity in elliptical or oblong form so as to enable insertion of the magnet above the center of the lower housing portion. It is further preferred that the lower housing portion has a supporting protrusion which supports an upper housing portion, and a yoke insertion groove on the bottom of the cavity.

To facilitate assembly and electrical contact, especially in applications where the buzzer is attached to a circuit board via SMT, solder grooves are formed in the lower housing portion so as to connect with the cavity, and tab insertion grooves are formed so as to connect with the solder grooves and to allow insertion of the tab from the outside of the lower housing portion into the housing portion. As in conventional buzzers, a yoke is located on the interior of the lower housing portion and a coil is wound around said yoke. In preferred embodiments, a pair of tabs is inserted into the insertion grooves and electrically connected/fastened to the coil using solder from the solder channels. It is still further generally preferred that the elliptical or oblong magnet has a channel on the bottom for passing a winding or other electrical connector from the coil to the tab channel, and an upwardly projecting supporting element of predetermined height. As pointed out above, it is especially preferred that the resonator has an elliptical or oblong shape and is coupled to the supporting element.

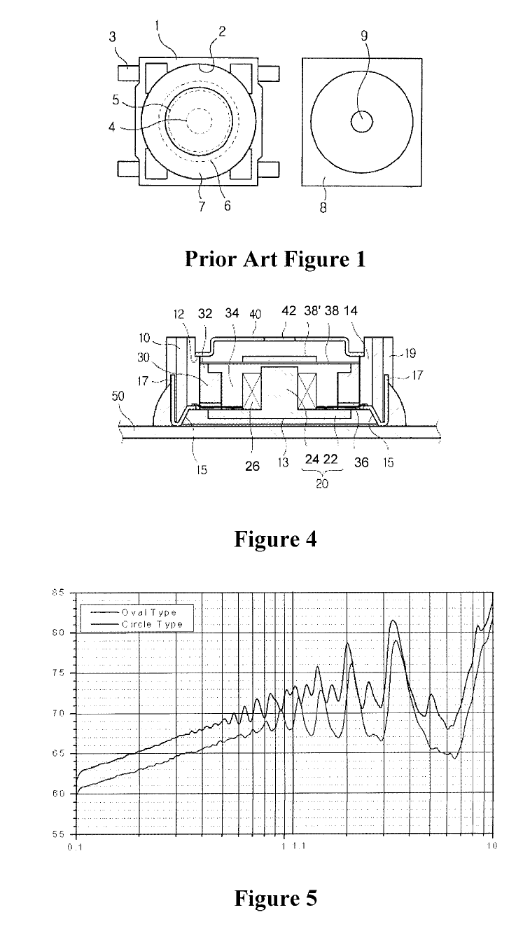

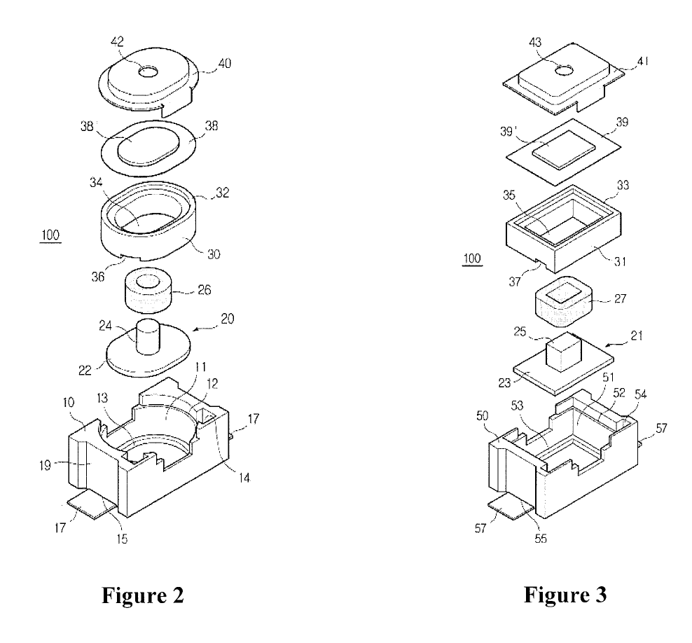

FIG. 2 depicts one preferred exemplary exploded oblique view of a slim-type magnetic buzzer according to the inventive subject matter, while FIG. 4 depicts the magnetic buzzer in an assembled state. With further reference to FIG. 2, buzzer (100) has a lower housing portion case (10), a yoke (20) disposed within the lower housing portion (10), a coil (26), a magnet (30) having elliptical shape, a resonator (38) having elliptical shape, a pair of tabs (17) connecting with either side of the lower part of the lower housing portion (10), and an upper housing portion (40) coupled to the lower housing portion (10). The lower housing portion (10) is preferably formed in the shape of a rectangle, with the elliptical cavity (11) formed in the housing. A supporting projection is formed on the interior surface of the cavity (11), a yoke insertion groove (13) is formed on the bottom of the interior of the cavity (11), and solder grooves (14) are formed on either side of the cavity (11) so as to connect to the cavity (11).

In addition, a tab insertion channel (15) is formed lengthwise on either side of the lower part of the lower housing portion (10). These tab insertion conduits (15) are formed so as to allow connection with the lower portion of the solder conduit (14). Since both tabs (17) are inserted into the tab insertion conduits to connect to electrical power and signals, it is preferred to insert the tabs (17) fully into the solder conduits (14). However, it is also contemplated to create tab holding grooves (19) on either side of the lower housing portion (10) on which the tab insertion conduits (15) are formed, which bend and hold the tabs (17) when inserted into the tab insertion conduits (15).

The yoke (20) typically comprises a base (22) that is inserted into the yoke insertion groove (13) that is formed on the bottom portion of the cavity (11). A preferably cylindrical projection (24) is formed on the top center of the base (22). Yoke (20) typically comprises a magnetized metallic substance, and a coil (26) is wound around the projection (24) of the yoke (20). In most typical embodiments, coil (26) is wound in a circular fashion and coupled to the projection (24). The magnet (30) is disposed in the cavity (11) of the lower housing portion (10). It is still further preferred that the exterior surface of the magnet (30) conforms to the shape of the cavity and so preferably has an elliptical or oblong shape. As the magnet is most preferably a ring magnet, an opening (34) of elliptical shape is formed in the central part. The projection (24) and the coil (26) are thus positioned in this opening (34). Additionally, it is preferred that a support element (32) projects at a fixed height along the exterior circumference of the top of the magnet (30), and that a retraction groove (36) is in the magnet in a location corresponding to the location of the solder conduit and/or tab insertion conduit. Therefore, a portion of the winding of the coil (26) can be retracted into the solder groove (14) through the retraction groove (36) so as to connect with the tabs (17).

The resonator (38) is preferably formed of an elastic membrane to generate sound pressure and is preferably attached to the support element (32) formed on the top of the magnet (30). It is especially preferred that the resonator (38) is formed in an elliptical shape, matching the exterior circumference of the magnet (30). A magnetic element (38′) is additionally coupled on top of the center of the resonator (38), and preferably comprises a magnetized metallic substance, shaped as a disc or an ellipse. The upper housing portion (40) typically includes an opening (42) which is preferably located in the center of the upper housing portion. The exterior circumference of the upper housing portion (40) is preferably coupled to the support element (12) on the cavity (11). Thus, the exterior of the upper case (40) may also be formed in an elliptical shape. With reference to FIG. 4, it should be noted that the assembled buzzer is soldered onto the printed circuit board (50) in a configuration in which the tabs are aligned with the tab holding grooves (19). Such arrangement advantageously improves electric and mechanical contact of the buzzer to the printed circuit board. Not shown in FIG. 4 is the solder in solder channel 14.

An alternative exemplary embodiment is shown in the cross-section of FIG. 3 in which slim-type magnetic buzzer (100) formed in a generally rectangular shape. Here, the cavity (51) is formed as a depression of oblong shape in the center of the lower housing portion (50). The support element (52) and yoke insertion groove (53) are formed in the interior of the cavity (51), and solder grooves (54) are formed on either side of the cavity (51). Additionally, tab insertion grooves (55) are formed on either side of the lower part of the lower housing portion (50), and the tabs (57) are fitted into the respective tab insertion grooves (55).

The yoke (21) comprises an oblong base (23) that is inserted into the yoke insertion groove (53) formed in the cavity (51), and further comprises an oblong projection (25), typically formed on the top center of the base (23). Coil (27) is wound around projection (25). The exterior of the magnet (31) is preferably formed into an oblong shape corresponding to the shape of the cavity (51), and an oblong opening (35) is formed in the center of the magnet (31). Where desired, a support element (33) projects at a fixed height along the exterior circumference of the top of the magnet (31), while a retraction groove (37) is formed on the bottom surface at a location corresponding to the solder groove (54). The resonator (39) is preferably coupled to the support element (33) that is formed on the top of magnet (31). It is generally preferred that the resonator has a shape that corresponds to the shape of the exterior of the magnet (31). As in the buzzer of FIG. 2, it is preferred that the resonator comprises a magnetic plate (39′), most typically coupled to the center of the top of the resonator (39). Magnetic plate (39′) is preferably manufactured from a magnetized metallic substance and is formed in an oblong shape. An opening (43) is preferably formed in the center of the upper housing portion (41), wherein the outer circumference of the upper portion is coupled to the support element (52) that is formed on the lower housing portion (50). Accordingly, the exterior of the upper housing portion (41) may also be formed in an oblong shape.

Hereinafter, the assembly and action of the slim-type magnetic buzzer is described with reference to FIG. 4. Here, a yoke (20) is inserted into the cavity (11) of the lower housing portion (10) which received the tabs (17) on either side of the housing. The base (22) of yoke (20) is inserted into the yoke insertion groove formed on the lower part of the receiving part, and the magnet (30) is inserted into the interior of the cavity. Thus, the magnet (30) is at least in part supported by the base (22) of yoke (20). The ring-shaped coil (26) is attached to the projection (24) of yoke (20). Either end of this coil (26) is retracted into the solder conduit (14) through the retraction groove (36); and soldered to the tab (17) within the solder conduit (14). The magnetic plate (38′) is then affixed to the center top of the resonator, and after the resonator (38) has been coupled to the support element (32) of magnet (30), the upper housing portion (40) is attached to the lower housing portion (10). The slim-type magnetic buzzer (100) thus assembled is attached to a printed circuit board (PCB). To that end, the tabs (17) are bent toward the upper housing portion (40) and positioned into the tab holding grooves (19). Thus, it should be appreciated that when the magnetic buzzer (100) is attached to the PCB (50), the area of solder is increased, which is expected not only to improve the transmission of electrical power and signals, but also to enhance the strength of attachment.

The coil (26) is powered via tabs (17), and yoke (20) is immediately electromagnetized by the magnetic field generated by the coil (26). Consequently, the magnetic plate (38′) affixed to the top of the vibrating plate (38) is pulled toward or pushed away from the yoke (20) by the magnetic field generated by the yoke (20). As power to the coil (26) is shut off or reversed, the resonator (38) elastically returns to its original state, and repetition of this cycle generates sound through vibration of the resonator (38), which emanates through the opening (42) in the upper housing portion (40). It should be particularly appreciated that as the air volume for sound is increased through the elliptical shape of the magnet (30) and resonator (38), an increase in the vibration amplitude of the resonator (38) is achieved, thus allowing generation of high-pitched sound at improved SPL.

FIG. 5 depicts an exemplary measurement of a conventional buzzer with circular resonator as compared to a buzzer according to the inventive subject matter in which the resonator had elliptical shape (but otherwise identical proportions). As can be clearly taken from FIG. 5, the SPL is substantially higher in the inventive device over a wide range of frequencies (here 0.1 kHz to 10 kHz). Therefore, it should be especially appreciated that the increased air volume in the buzzer and/or the increased range of resonator excursion enables a more intense sound signal due to the increased membrane amplitude. Furthermore, the tab and solder conduits allow a more secure and more conductive attachment of the buzzer to the PCB. Therefore, and viewed from a different perspective, it is contemplated that a method of reducing size of a buzzer while maintaining or even increasing SPL, or a method of increasing SPL in a buzzer will have a step in which a resonator geometry is modified from a circular shape to an elliptic or oblong shape. In contemplated methods and devices, a circular resonator with radius R is modified such that an elliptical or oblong resonator is formed with a small axis having a length L1 and a large axis having a length L2, wherein L2 is R or less than R. Therefore, the elliptical shape of the resonator in contemplated devices is characterized by a ratio of major axis to minor axis of at least 1.05, more preferably at least 1.1, and most typically at least 1.25.

Thus, specific embodiments and applications of slim-type magnetic buzzers have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A magnetic buzzer comprising:
a housing having a cavity, a solder conduit, and a tab insertion conduit that is formed between the cavity and an outside surface of the housing, wherein the solder conduit is fluidly coupled to the tab insertion conduit;
a yoke disposed in the cavity, and a coil surrounding the yoke;
a magnet having elliptical or oblong shape, and further having an upper support element and a lower retraction channel, wherein the magnet is disposed in the cavity and surrounds the yoke and coil;
a resonator having elliptical or oblong shape, wherein the resonator is coupled to the upper support element; and
a tab partially located in the tab insertion conduit, and solder in the solder conduit in an amount effective to conductively fasten a winding of the coil to the tab, wherein the winding extends at least partially through the lower retraction channel.

2. The buzzer of claim 1 wherein the outside surface of the housing is recessed to form a tab holding groove that is configured to receive substantially all of the tab that is outside of the housing.

3. The buzzer of claim 1 wherein the cavity further comprises a protrusion that is configured to allow positioning of the magnet at a position above a yoke plate.

4. The buzzer of claim 1 wherein the housing further comprises a support structure that is configured to allow coupling of a cover to the housing in a position above the resonator.

5. The buzzer of claim 1 wherein the elliptical shape is characterized by a ratio of major axis to minor axis of at least 1.05.

6. The buzzer of claim 1 wherein the elliptical shape is characterized by a ratio of major axis to minor axis of at least 1.1.

7. The buzzer of claim 1 wherein the elliptical shape is characterized by a ratio of major axis to minor axis of at least 1.25.

8. The buzzer of claim 1 wherein the oblong shape is a rectangular shape.

9. The buzzer of claim 1 wherein the resonator comprises a vibrating plate and a magnetic element centrally located on the vibrating plate.

10. A magnetic buzzer having a lower housing portion with tab insertion grooves, a yoke located in an interior of the lower housing portion, a coil wound around the yoke, and an upper housing portion coupled to the lower housing portion, the buzzer comprising:
a pair of tabs inserted into the respective tab insertion grooves, wherein the tabs are electrically connected to the coil and an optional power source;
an elliptical or oblong magnet located in the interior of the lower housing portion, further having a supporting projection at a predetermined height along the top of the magnet, and still further having retraction grooves formed at either side of the bottom of the magnet; and
an elliptical or oblong resonator coupled to the supporting projection, wherein the resonator further comprises a magnetic plate coupled to the top center of the resonator.

11. The magnetic buzzer of claim 10, wherein the interior has a corresponding elliptical or oblong shape so as to permit insertion of the magnet, a supporting projection in the interior that is configured to support the upper housing portion, and a yoke insertion groove in the interior that is configured to allow insertion of the yoke.

12. The magnetic buzzer of claim 11 further comprising solder grooves formed on either side of the supporting projection, and tab insertion grooves formed on either side of the lower housing portion that are in fluid communication with the solder grooves.

13. The magnetic buzzer of claim 12 wherein the resonator is elliptical.

14. The magnetic buzzer of claim 12 wherein the resonator comprises a vibrating plate and a magnetic element centrally located on the vibrating plate.

15. The buzzer of claim 12 wherein the elliptical shape is characterized by a ratio of major axis to minor axis of at least 1.05.

16. The buzzer of claim 12 wherein the elliptical shape is characterized by a ratio of major axis to minor axis of at least 1.1.

17. The buzzer of claim 12 wherein the elliptical shape is characterized by a ratio of major axis to minor axis of at least 1.25.
